(19) United States
(12) Patent Application Publication
(10) Pub. No.: US 2021/0064242 A1
(43) Pub. Date: Mar. 4, 2021

(54) MEMORY SYSTEM FOR PREDICTING WHETHER INTERNAL OPERATION IS PERFORMABLE AND DATA PROCESSING SYSTEM INCLUDING THE SAME

(71) Applicant: SK hynix Inc., Gyeonggi-do (KR)

(72) Inventor: Seok-Jun LEE, Seoul (KR)

(21) Appl. No.: 16/844,002

(22) Filed: Apr. 9, 2020

(30) Foreign Application Priority Data
Aug. 26, 2019 (KR) 10-2019-0104198

(51) Int. Cl. G06F 3/06

(52) U.S. Cl. CPC G06F 3/064; G06F 3/0652; G06F 3/0653; G06F 3/0679; G06F 3/0659; G06F 3/0604; G06F 3/0658

(57) ABSTRACT

A memory system comprising: a memory device including a plurality of memory blocks; and a controller suitable for: periodically generating, based on system information periodically inputted from a host, performance information indicating whether an internal operation to be performed on the plurality of memory blocks without a command inputted from the host is performable; accumulatively storing the generated performance information; determining whether the internal operation is performable within a period subsequent to a current period based on the accumulated performance information; and performing the internal operation on the memory blocks during the subsequent period according to a result of the determination.

### CROSS-REFERENCE TO RELATED APPLICATIONS

The present application claims priority under 35 U.S.C. § 119(a) to Korean Patent Application No. 10-2019-0104198, filed on Aug. 26, 2019, the disclosure of which is incorporated herein by reference in its entirety.

### BACKGROUND

### 1. Field

Various exemplary embodiments relate to a memory system, and particularly, to a memory system capable of predicting whether an internal operation can be performed and a data processing system including the memory system.

### 2. Description of the Related Art

Recently, a computer environment paradigm has shifted to ubiquitous computing, which enables a computer system to be accessed virtually anytime and everywhere. As a result, the use of portable electronic devices such as mobile phones, digital cameras, notebook computers and the like increases. Such portable electronic devices typically use or include a memory system that uses or embeds at least one memory device, i.e., a data storage device. The data storage device can be used as a main storage device or an auxiliary storage device of a portable electronic device.

In a computing device, unlike a hard disk, a data storage device used as a nonvolatile semiconductor memory device is advantageous in that it has excellent stability and durability because it has no mechanical driving part (e.g., a mechanical arm), and has high data access speed and low power consumption. Examples of such a data storage device include a universal serial bus (USB) memory device, a memory card having various interfaces, and a solid state drive (SSD).

### SUMMARY

Various embodiments of the present disclosure are directed to a memory system, a data processing system and an operating method of the memory system, which may minimize complexity and performance degradation of the memory system, maximize use efficiency of a memory device, and rapidly and stably process data within the memory device.

Various embodiments of the present disclosure are directed to a memory system and a data processing system including the same, which may determine whether to perform an internal operation by predicting whether the internal operation is performable based on system information, which is periodically inputted from a host.

These and other features and advantages of the present disclosure are not limited to the embodiments described above, and will be understood by those skilled in the art to which the present disclosure pertains from the following detailed description in conjunction with the accompanying drawings.

In accordance with an embodiment of the present invention, a memory system may include: a memory device including a plurality of memory blocks; and a controller suitable for: periodically generating, based on system information periodically inputted from a host, performance information indicating whether an internal operation to be performed on the plurality of memory blocks without a command inputted from the host is performable; accumulatively storing the generated performance information; determining whether the internal operation is performable within a period subsequent to a current period based on the accumulated performance information; and performing the internal operation on the memory blocks during the subsequent period according to a result of the determination.

The system information may include: power supply information indicating stability and sustainability of power supply within each period; reservation operation information indicating whether a command to be transmitted from the host is present within each period; and operation environment information on an operation environment of the host within each period.

The controller may generate the performance information indicating the internal operation is performable at each period when the controller determines the power supply is stable and sustainable within the period, the command to be transmitted from the host within the period is not present and the operation environment is an environment in which the internal operation is performable within the period.

The controller may determine whether the internal operation is performable within the subsequent period based on one or more most recent pieces within the accumulated performance information.

The controller may determine whether the internal operation is performable within the subsequent period based on a pattern of the most recent pieces.

The controller may determine the internal operation is unperformable within the subsequent period when the controller does not detect the pattern as having any tendency or detects the pattern as indicating that the internal operation is unperformable within the subsequent period, and the controller may skip the internal operation within the subsequent period when the controller determines the internal operation is unperformable within the subsequent period.

The operation environment information may include at least one of pieces of information on a temperature and information on mobility of the memory system.

The controller may be further suitable for interrupting the internal operation and performing an operation in response to a command, which is inputted from the host while the internal operation is being performed.

When the internal operation is an erase operation, the controller may be further suitable for managing an erase block list for a block required to be erased among the plurality of memory blocks, when the internal operation is a background operation, the controller may be further suitable for managing a source block list for a block satisfying a reference condition of the background operation among the plurality of memory blocks, the controller may perform the erase operation with reference to the erase block list, and the controller may perform the background operation with reference to the source block list.

In accordance with an embodiment of the present invention, a data processing system may include: a host suitable for periodically generating and outputting system information; and a memory system including a memory device that includes a plurality of memory blocks, and suitable for: periodically generating, based on the system information, performance information indicating whether an internal operation to be performed on the plurality of memory blocks without a command inputted from the host is performable; accumulatively storing the generated performance information; determining whether the internal operation is performable within a period subsequent to a current period based on the accumulated performance information; and performing the internal operation on the memory blocks during the subsequent period according to a result of the determination.

The system information may include: power supply information indicating stability and sustainability of a power supply within each period; reservation operation information indicating whether a command to be transmitted from the host is present within each period; and operation environment information on an operation environment of the host within each period.

The memory system may generate the performance information indicating the internal operation is performable at each period when the memory system determines the power supply is stable and sustainable within the period, the command to be transmitted from the host within the period is not present and the operation environment is an environment in which the internal operation is performable within the period.

The memory system may determine whether the internal operation is performable within the subsequent period on a basis of one or more most recent pieces within the accumulated performance information.

The memory system may determine whether the internal operation is performable within the subsequent period on a basis of a pattern of the most recent pieces.

The memory system may determine the internal operation is unperformable within the subsequent period when the memory system does not detect the pattern or detects the pattern as indicating that the internal operation is unperformable within the subsequent period, and the memory system may skip the internal operation within the subsequent period when the memory system determines the internal operation is unperformable within the subsequent period.

The operation environment information may include at least one of pieces of information on a temperature and information on mobility of the memory system.

The memory system may be further suitable for interrupting the internal operation and performing an operation in response to a command, which is inputted from the host while the internal operation is being performed.

When the internal operation is an erase operation, the memory system may be further suitable for managing an erase block list for a block required to be erased among the plurality of memory blocks, when the internal operation is a background operation, the memory system may be further suitable for managing a source block list for a block satisfying a reference condition of the background operation among the plurality of memory blocks, the memory system may perform the erase operation with reference to the erase block list, and the memory system may perform the background operation with reference to the source block list.

The host may be further suitable for, when the memory system is in a sleep mode, changing the sleep mode to a wake mode then outputting the system information to the memory system.

In accordance with an embodiment of the present invention, an operating method of a controller for controlling a memory device, the operating method may include: gathering, periodically and for a predetermined time duration, first information on performability of an internal operation of the memory device during each period; and controlling the memory device to perform the internal operation based on a value pattern of the gathered first information, the first information may be gathered at each period based on second information indicating one or more among: stability and sustainability of a power supply within the period; a command to be provided within the period, the command requesting a dependent operation of the memory device; and an operation environment of the memory device within the period.

### BRIEF DESCRIPTION OF THE DRAWINGS

FIG. 1 is a block diagram illustrating a data processing system including a memory system in accordance with an embodiment of the present invention.

FIG. 2 is a block diagram illustrating an example of a data processing system including a memory system in accordance with an embodiment of the present invention.

FIG. 3 is a block diagram illustrating a controller included in a memory system in accordance with an embodiment of the present invention.

FIG. 4 is a table illustrating an example of an operating method of a memory system in accordance with an embodiment of the present invention.

### DETAILED DESCRIPTION

Various examples of the disclosure are described below in more detail with reference to the accompanying drawings. Aspects and features of the present invention, however, may be embodied in different ways to form other embodiments, including variations of any of the disclosed embodiments. Thus, the invention is not to be construed as being limited to the embodiments set forth herein. Rather, the described embodiments are provided so that this disclosure is thorough and complete, and fully conveys the disclosure to those skilled in the art to which this invention pertains.

Throughout the disclosure, like reference numerals refer to like parts throughout the various figures and examples of the disclosure. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could be termed a second or third element in another instance without departing from the spirit and scope of the invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via one or more intervening elements therebetween. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the invention. As used herein, singular forms are intended to include the plural forms and vice versa, unless the context clearly indicates otherwise. Similarly, the indefinite articles “a” and “an” mean one or more, unless it is clear from the language or context that only one is intended.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the invention belongs in view of the disclosure. It will be further understood that terms, such as those defined in commonly used dictionaries, should be interpreted as having a meaning that is consistent with their meaning in the context of the disclosure and the relevant art, and not be interpreted in an idealized or overly formal sense unless expressly so defined herein.

In the following description, numerous specific details are set forth in order to provide a thorough understanding of the invention. The invention may be practiced without some or all of these specific details. In other instances, well-known process structures and/or processes have not been described in detail in order not to unnecessarily obscure the invention.

It is also noted, that in some instances, as would be apparent to those skilled in the relevant art, a feature or element described in connection with one embodiment may be used singly or in combination with other features or elements of another embodiment, unless otherwise specifically indicated.

Embodiments of the disclosure are described in detail below with reference to the accompanying drawings, wherein like numbers reference like elements.

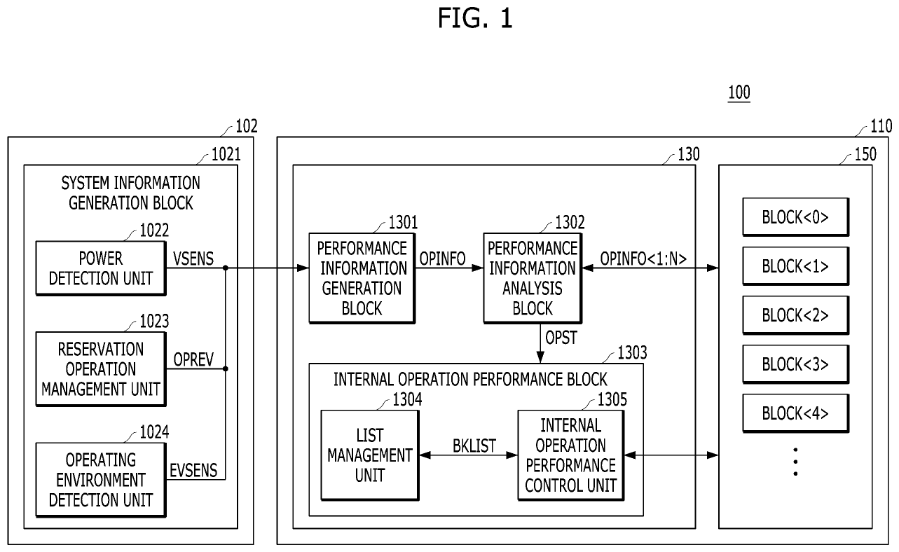

FIG. 1 is a block diagram illustrating a data processing system 100 including a memory system 110 in accordance with an embodiment of the present invention.

For example, the memory system 110 may be mounted on a computing device or a mobile device, and then transmit and receive data in connection with a host 102.

Referring to FIG. 1, the data processing system 100 includes the host 102 and the memory system 110. The memory system 110 includes a controller 130 and a memory device 150. The controller 130 includes a performance information generation block 1301, a performance information analysis block 1302 and an internal operation performance block 1303. The internal operation performance block 1303 includes a list management unit 1304 and an internal operation performance control unit 1305. The memory device 150 includes a plurality of memory blocks BLOCK<0, 1, 2, 3, 4, . . . >. The host 102 includes a system information generation block 1021.

The controller 130 may perform a read operation, a program operation, an erase operation and a background operation. The controller 130 may perform the read operation to output data requested by the host 102 or data required in the memory system 110 from the memory device 150. The controller 130 may perform the program operation to store the data transferred from the host 102 or the data generated in the memory system 110 in the memory device 150. The controller 130 may perform the erase operation to erase the data stored in the memory device 150. The controller 130 may perform the background operation to manage the data stored in the memory device 150.

The internal configuration of the memory device 150 may be changed depending on characteristics of the memory device 150, a purpose for which the memory system 110 is used, or specifications of the memory system 110 requested by the host 102.

For example, the memory device 150 may be implemented as a non-volatile memory device, a NAND flash memory, a vertical NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (SU-RAM) or the like.

The memory device 150 may be implemented as a three-dimensional array structure. Embodiments of the present disclosure may be applied to a charge trap flash (CTF) in which a charge storage layer is formed of a dielectric layer as well as a flash memory device in which a charge storage layer is formed of a conductive floating gate.

The memory device 150 is configured to receive a command and an address from the controller 130 and to access a region of the memory cell array, which is selected by the address. In other words, the memory device 150 may perform an operation corresponding to the command on the region selected by the address.

For example, the memory device 150 may perform the program operation, the read operation and the erase operation. In this regard, the memory device 150 may program data into the region selected by the address, during the program operation. During the read operation, the memory device 150 may read data from the region selected by the address. During the erase operation, the memory device 150 may erase data stored in the region selected by the address.

The controller 130 may control the operations of the memory device 150 according to the request of the host 102 or regardless of the request of the host 102.

For example, the controller 130 may control the write, i.e., program, read, erase and background operations of the memory device 150. The background operation may be, for example, a garbage collection (GC) operation, a wear leveling (WL) operation, a bad block management (BBM) operation or the like.

The controller 130 may control an operation of the memory system 110 by executing firmware. In order to control the overall operations of the memory device 150 and perform logical operations, the controller 130 may load and execute or drive the firmware into a memory 144 during boot-up time. For example, the firmware may be stored in the memory device 150, and then loaded into the memory 144.

The firmware, which is a program executed in the memory system 110, may include, for example, a flash translation layer (FTL), a host interface layer (HIL) and a flash interface layer (FIL). The FTL may perform a translation function between a logical address of the memory system 110 requested by the host 102 and a physical address of the memory device 150. The HIL may serve to interpret a command requested by the host 102 from the memory system 110, which is a storage device, and transfer the command to the FTL. The FIL may transfer a command, which is instructed by the FTL, to the memory device 150.

The host 102 according to the present embodiment may periodically generate and output system information VSENS, OPREV and EVSENS to the memory system 110. For example, when a period is an hour, the host 102 may generate and output the system information VSENS, OPREV and EVSENS to the memory system 110 each hour.

The host 102 may check whether the memory system 110 is in a wake state at each period of generating and outputting the system information VSENS, OPREV and EVSENS to the memory system 110. When the memory system 110 is in a sleep state at the start of the period, the host 102 may change the state of the memory system 110 to the wake state, and then output the system information VSENS, OPREV and EVSENS to the memory system 110.

The system information VSENS, OPREV and EVSENS may include at least one of power supply information VSENS, reservation operation information OPREV and operation environment information EVSENS.

The power supply information VSENS may be generated by a power detection unit 1022 included in the system information generation block 1021. In other words, the power detection unit 1022 may check a power supply state detected at each period, and output the power supply state as the power supply information VSENS to the memory system 110. For example, when the data processing system 100 including the host 102 is a mobile device, the power detection unit 1022 may generate information corresponding to whether the mobile device is being charged and information of a currently remaining battery level, as the power supply information VSENS.

The reservation operation information OPREV may be generated by a reservation operation management unit 1023 included in the system information generation block 1021. In other words, the reservation operation management unit 1023 may check whether there is a reserved command of the host 102 to be transmitted to the memory system 110 within each period. For example, when the data processing system 100 including the host 102 is a mobile device, the reservation operation management unit 1023 may generate information corresponding to whether the mobile device has an operation that is reserved in advance and information on whether the reserved operation is to be performed within each period, as the reservation operation information OPREV.

The operation environment information EVSENS may be generated by an operation environment detection unit 1024 included in the system information generation block 1021. In other words, the operation environment detection unit 1024 may check an operation environment of the host 102, which is detected at each period, and output the operation environment as the operation environment information EVSENS to the memory system 110. For example, when the data processing system 100 including the host 102 is a mobile device, the operation environment detection unit 1024 may generate information on an internal temperature or an external temperature of the mobile device and information on mobility of the mobile device, as the operation environment information EVSENS.

The memory system 110 may periodically generate performance information OPINFO indicating whether an internal operation can be performed on the plurality of memory blocks BLOCK<0, 1, 2, 3, 4, . . . > during each period in response to the system information VSENS, OPREV and EVSENS inputted from the host 102, and store the performance information OPINFO as accumulated pieces of performance information OPINFO<1:N>. In addition, the memory system 110 may estimate the performability of the internal operation during a current period based on the accumulated pieces of performance information OPINFO<1:N>, which are accumulated for a predetermined time duration of a plurality of the periods, and perform the internal operation on the plurality of memory blocks BLOCK<0, 1, 2, 3, 4, . . . > according to a result of the estimation. The internal operation may be performed within the memory system 110 without any command or data provided from the host 102. For example, the internal operation of the memory system 110 may be the erase operation performed on some blocks that need to be erased among the plurality of memory blocks BLOCK<0, 1, 2, 3, 4, . . . >. In addition, the internal operation of the memory system 110 may be a background operation performed on some of the plurality of memory blocks BLOCK<0, 1, 2, 3, 4, . . . >, that is, a garbage collection operation, a wear leveling operation, a read reclaim operation and a bad block management operation.

Specifically, the performance information generation block 1301 included in the controller 130 of the memory system 110 may generate the performance information OPINFO indicating whether the internal operation can be performed on the plurality of memory blocks BLOCK<0, 1, 2, 3, 4, . . . > within each period in response to the system information VSENS, OPREV and EVSENS periodically inputted from the host 102. The performance information generation block 1301 may periodically generate one piece of performance information OPINFO.

In this case, the system information VSENS, OPREV and EVSENS may include at least one of the power supply information VSENS, the reservation operation information OPREV and the operation environment information EVSENS.

Accordingly, when it is determined through the power supply information VSENS that the power supply is stable and sustainable for each period, the performance information generation block 1301 may determine that the internal operation of the memory system 110 is performable during each period, and generate the performance information OPINFO indicating the internal operation as performable. In other words, the performance information generation block 1301 may check the power supply state of the host 102 at each period through the power supply information VSENS, and determine whether the power supply is stable and sustainable during each period, through a result of the check.

For example, when the data processing system 100 including the host 102 and the memory system 110 is a mobile device, information indicating that the mobile device is being charged and a current remaining battery level is 80% may be included in the power supply information VSENS inputted from the host 102. When such power supply information VSENS is inputted at each period, the performance information generation block 1301 may determine that the power supply will be stable and sustainable during each period. Accordingly, the performance information generation block 1301 may determine that the internal operation of the memory system 110 is performable at each period, and generate the performance information OPINFO indicating the internal operation is performable. Alternatively, information indicating that the mobile device is not being charged and the current remaining battery level is 5% may be included in the power supply information VSENS inputted from the host 102. When such power supply information VSENS is inputted at each period, the performance information generation block 1301 may determine that the power supply is not stable and sustainable during each period. Therefore, the performance information generation block 1301 may determine that the internal operation of the memory system 110 is not performable at each period, and generate the performance information OPINFO indicating the internal operation is unperformable.

When it is determined through the reservation operation information OPREV that there is no command to be transmitted from the host 102 to the memory system 110 during each period, the performance information generation block 1301 may determine that the internal operation of the memory system 110 is performable at each period, and generate the performance information OPINFO indicating the internal operation is performable. That is, the performance information generation block 1301 may check whether a reserved command to be transmitted to the memory system 110 is present in the host 102 at each period, through the reservation operation information OPREV, and check a time point at which the command is to be performed. When there is no command or it is checked that the command is not to be performed within each period even though there is a command, the performance information generation block 1301 may determine that the internal operation of the memory system 110 is performable during each period, and generate the performance information OPINFO indicating the internal operation is performable.

When it is determined through the operation environment information EVSENS that an operation environment is an environment in which the internal operation of the memory system 110 is performable at each period, the performance information generation block 1301 may generate the performance information OPINFO indicating the internal operation is performable. In other words, the performance information generation block 1301 may check an operation environment of the host 102 at each period through the operation environment information EVSENS, and determine whether the operation environment of the host 102 is the environment in which the internal operation of the memory system 110 is performable during each period, through a result of the check.

For example, when the data processing system 100 including the host 102 and the memory system 110 is a mobile device, information indicating that an internal temperature or an external temperature of the mobile device is 25 degrees and the mobile device is not moving may be included in the operation environment information EVSENS inputted from the host 102. When such operation environment information EVSENS is inputted at each period, the performance information generation block 1301 may determine that the operation environment is an environment in which the internal operation of the memory system 110 is performable during each period. Accordingly, the performance information generation block 1301 may determine that the internal operation of the memory system 110 is performable during each period, and generate the performance information OPINFO indicating the internal operation is performable. Alternatively, information indicating that the internal temperature or the external temperature of the mobile device is 55 degrees and the mobile device is moving may be included in the operation environment information EVSENS inputted from the host 102. When such operation environment information EVSENS is inputted at each period, the performance information generation block 1301 may determine that the operation environment is an environment in which the internal operation of the memory system 110 is not performable during each period. Accordingly, the performance information generation block 1301 may determine that the internal operation of the memory system 110 is not performable during each period, and generate the performance information OPINFO indicating the internal operation is unperformable.

The above description exemplifies that the performance information generation block 1301 generates the performance information OPINFO in response to any one of the power supply information VSENS, the reservation operation information OPREV and the operation environment information EVSENS. This is only an embodiment of the present disclosure provided for convenience of description, and as another example, the performance information generation block 1301 may also perform the operation of generating the performance information OPINFO in response to at least two of the power supply information VSENS, the reservation operation information OPREV and the operation environment information EVSENS. The performance information generation block 1301 may also perform the operation of generating the performance information OPINFO in response to all of the power supply information VSENS, the reservation operation information OPREV and the operation environment information EVSENS. In other words, when it is determined that the power supply is stable and sustainable during each period, through the power supply information VSENS, the command to be transmitted from the host 102 is not present during each period, through the reservation operation information, and the operation environment is an environment in which the internal operation can be performed, through the operation environment information EVSENS, the controller 130 of the memory system 110 may determine that the internal operation is performable in the memory system 110, and generate the performance information OPINFO indicating the internal operation is performable.

The performance information analysis block 1302 included in the controller 130 of the memory system 110 may accumulate the performance information OPINFO generated by the performance information generation block 1301, and store the accumulated pieces of performance information OPINFO<1:N> in the memory device 150. Subsequently, the performance information analysis block 1302 may analyze the accumulated pieces of performance information OPINFO<1:N>, and selectively perform the internal operation on the plurality of memory blocks BLOCK<0, 1, 2, 3, 4, . . . > according to a result of the analysis. In this case, the fact that the performance information analysis block 1302 analyzes the pieces of performance information OPINFO<1:N> corresponding to the respective periods means that the memory system 110 estimates the performability of the internal operation at a current period based on the pieces of performance information OPINFO<1:N> accumulated for a predetermined time duration of the plurality of previous periods, and selects whether to perform the internal operation on the memory system 110 at the current period according to a result of the estimation.

Specifically, the performance information analysis block 1302 may not analyze the accumulated pieces of performance information OPINFO<1:N> but store the values of the pieces of performance information OPINFO<1:N> in the memory device 150 until a number of the accumulated pieces of the performance information OPINFO periodically generated by the performance information generation block 1301 becomes a predetermined number. For example, when the period is an hour, and the performance information analysis block 1302 does not analyze the accumulated pieces of performance information OPINFO<1:N> until the number of the accumulated pieces of the performance information OPINFO becomes 24, the pieces of the performance information OPINFO periodically generated by the performance information generation block 1301 may be accumulated and stored in the memory device 150 for 24 hours.

When the accumulated pieces of performance information OPINFO<1:N> is accumulated by the predetermined number, the performance information analysis block 1302 may check a value pattern of the accumulated pieces of performance information OPINFO<1:N>, predict performance information OPINFO<N+1>, which are subsequently to be accumulated, according to a result of the check, and determine whether to perform the internal operation on the memory blocks BLOCK<0, 1, 2, 3, 4, . . . >, according to a result of the prediction. In addition, when the pieces of performance information OPINFO<1:N> are accumulated more than the predetermined number, the performance information analysis block 1302 may check a value pattern of at least some pieces of performance information OPINFO<N−K:N> which are recently accumulated among the accumulated pieces of performance information OPINFO<1:N>, predict the performance information OPINFO<N+1>, which are subsequently to be accumulated, according to a result of the check, and determine whether to perform the internal operation on the memory blocks BLOCK<0, 1, 2, 3, 4, . . . >, according to a result of the prediction. Herein, “K” may be a natural number less than or equal to “N”. In this case, when the pieces of performance information OPINFO<1:N> are accumulated by a predefined limit number since the pieces of performance information OPINFO<1:N> cannot be accumulated indefinitely, the performance information analysis block 1302 may sequentially remove the performance information OPINFO<1:N>, starting from the oldest accumulated performance information.

Specifically, when the pieces of performance information OPINFO<N+1>, which are subsequently to be accumulated, predict that the internal operation is performable through the value pattern of at least some pieces of performance information OPINFO<N−K:N> of the accumulated pieces of performance information OPINFO<1:N>, the performance information analysis block 1302 may enable an operation start signal OPST during the subsequent period so that the internal operation performance block 1303 can perform the internal operation on the memory blocks BLOCK<0, 1, 2, 3, 4, . . . > within the subsequent period. In addition, when the number of pieces of performance information indicating the internal operation is performable is more than the number of pieces of performance information indicating the internal operation is unperformable among at least some pieces of performance information OPINFO<N−K:N> of the accumulated pieces of performance information OPINFO<1:N>, the performance information analysis block 1302 may enable the operation start signal OPST during the subsequent period so that the internal operation performance block 1303 can perform the internal operation on the memory blocks BLOCK<0, 1, 2, 3, 4, . . . > for the subsequent period. Furthermore, when the pieces of performance information OPINFO<N+1>, which are subsequently to be accumulated, predict that the internal operation is performable through the value pattern checked on at least some pieces of performance information OPINFO<N−K:N> of the accumulated pieces of performance information OPINFO<1:N>, and the number of pieces of performance information indicating the internal operation is performable is more than the number of pieces of performance information indicating the internal operation is unperformable among at least some pieces of performance information OPINFO<N−K:N> of the accumulated pieces of performance information OPINFO<1:N>, the performance information analysis block 1302 may enable the operation start signal OPST during the subsequent period so that the internal operation performance block 1303 can perform the internal operation on the memory blocks BLOCK<0, 1, 2, 3, 4, . . . > for the subsequent period.

Alternatively, when the value pattern of at least some pieces of performance information OPINFO<N−K:N> of the accumulated pieces of performance information OPINFO<1:N> cannot be determined, the performance information analysis block 1302 may disable the operation start signal OPST during the subsequent period so that the internal operation performance block 1303 cannot perform the internal operation on the memory blocks BLOCK<0, 1, 2, 3, 4, . . . > for the subsequent period. In addition, when the pieces of performance information OPINFO<N+1>, which are subsequently to be accumulated, indicate the internal operation is unperformable through the value pattern checked on at least some pieces of performance information OPINFO<N−K:N> of the accumulated pieces of performance information OPINFO<1:N>, the performance information analysis block 1302 may disable the operation start signal OPST during the subsequent period so that the internal operation performance block 1303 cannot perform the internal operation on the memory blocks BLOCK<0, 1, 2, 3, 4, . . . > for the subsequent period. Furthermore, when the number of pieces of performance information indicating the internal operation is unperformable is more than the number of pieces of performance information indicating the internal operation is performable among at least some pieces of performance information OPINFO<N−K:N> of the accumulated pieces of performance information OPINFO<1:N>, the performance information analysis block 1302 may disable the operation start signal OPST so that the internal operation performance block 1303 cannot perform the internal operation on the memory blocks BLOCK<0, 1, 2, 3, 4, . . . > for the subsequent period.

The internal operation performance block 1303 may perform the internal operation on the memory blocks BLOCK<0, 1, 2, 3, 4, . . . >, included in the memory device 150, in response to the state of the operation start signal OPST inputted from the performance information analysis block 1302. In other words, the internal operation performance block 1303 may perform the internal operation on the memory blocks BLOCK<0, 1, 2, 3, 4, . . . > during a period in which the operation start signal OPST inputted from the performance information analysis block 1302 is enabled. On the contrary, the internal operation performance block 1303 may not perform the internal operation on the memory blocks BLOCK<0, 1, 2, 3, 4, . . . > during a period in which the operation start signal OPST inputted from the performance information analysis block 1302 is disabled.

In addition, the internal operation performance block 1303 may interrupt the internal operation being performed, when a command is inputted from the host 102, while performing the internal operation, in response to the operation start signal OPST being enabled. In other words, the host 102 may transmit the command to the memory system 110 at an unexpected time point, and the time point that the command is transmitted may be the time that the internal operation performance block 1303 of the controller 130 is performing the internal operation. In this case, the internal operation performance block 1303 may interrupt the internal operation being performed. At this time, the controller 130 may perform an operation corresponding to the command inputted from the host 102, apart from interrupting the internal operation by the internal operation performance block 1303.

The list management unit 1304 included in the internal operation performance block 1303 may manage a block on which the internal operation is required to be performed, among the memory blocks BLOCK<0, 1, 2, 3, 4, . . . > included in the memory device 150, in a list form. For example, when the internal operation is the erase operation, the list management unit 1304 may manage an erase block list for a block on which the erase operation is required to be performed, among the memory blocks BLOCK<0, 1, 2, 3, 4, . . . >. For another example, when the internal operation is the background operation, the list management unit 1304 may manage a source block list for a block, which satisfies a reference condition of the background operation, among the memory blocks BLOCK<0, 1, 2, 3, 4, . . . >.

During the period in which the operation start signal OPST is enabled, the internal operation performance control unit 1305 included in the internal operation performance block 1303 may perform the internal operation, for example, the erase or background operation, on the memory blocks BLOCK<0, 1, 2, 3, 4, . . . > included in the memory device 150, with reference to a block list BKLIST inputted from the list management unit 1304, for example, the erase block list or the source block list. In addition, during the period in which the operation start signal OPST is enabled, the internal operation performance block 1303 may interrupt the internal operation being performed, when the command is inputted from the host 102, while performing the internal operation on the memory blocks BLOCK<0, 1, 2, 3, 4, . . . >.

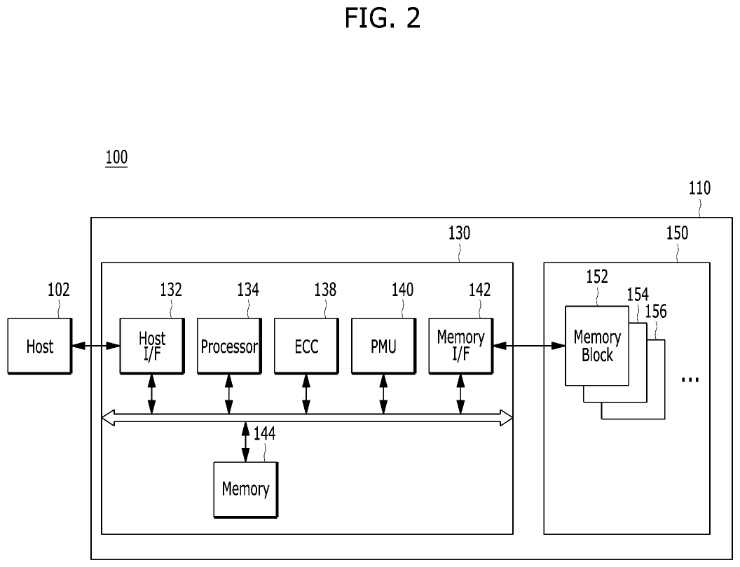

FIG. 2 is a block diagram illustrating an example of a data processing system including a memory system in accordance with an embodiment of the present invention.

Referring to FIG. 2, the data processing system 100 may include a host 102 engaged or operably coupled with a memory system 110.

The host 102 may include, for example, any of a variety of portable electronic devices, such as a mobile phone, an MP3 player and a laptop computer, or an electronic device such as a desktop computer, a game player, a television (TV), a projector and the like.

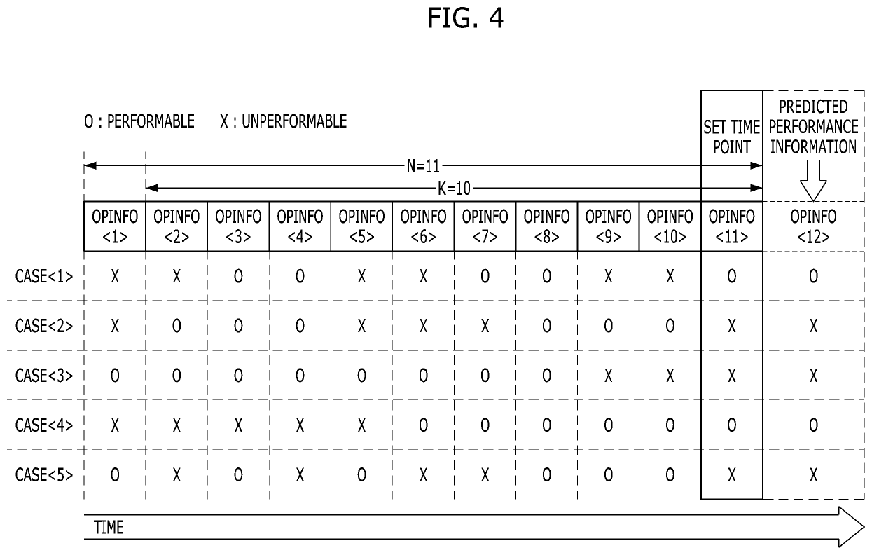

The host 102 also includes at least one operating system (OS), which can generally manage and control, functions and operations performed in the host 102. The OS may provide interoperability between the host 102 engaged with the memory system 110 and the user of the memory system 110. The OS may support functions and operations corresponding to a user's requests. By way of example but not limitation, the OS may include a general operating system and a mobile operating system according to mobility of the host 102. The general operating system may be split into a personal operating system and an enterprise operating system according to system requirements or a user's environment. The personal operating system, including Windows and Chrome, may be subject to support services for general purposes. The enterprise operating systems may be specialized for securing and supporting high performance, including Windows servers, Linux and Unix. Further, the mobile operating system may include an Android, an iOS and a Windows mobile. The mobile operating system may be subject to support services or functions for mobility (e.g., a power saving function). The host 102 may include a plurality of operating systems. The host 102 may execute multiple operating systems in cooperation with the memory system 110, corresponding to a user's request. The host 102 may transmit a plurality of commands corresponding to the user's requests into the memory system 110, thereby performing operations corresponding to commands within the memory system 110. Handling plural commands in the memory system 110 is described below with reference to FIGS. 4 and 5.

The memory system 110 may perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card and a memory stick.

The storage devices for the memory system 110 may be implemented with a volatile memory device, for example, a dynamic random access memory (DRAM) or a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) or a flash memory.

The memory system 110 may include a controller 130 and a memory device 150. The memory device 150 may store data to be accessed by the host 102. The controller 130 may control storage of data in the memory device 150.

The controller 130 and the memory device 150 may be integrated into a single semiconductor device, which may be included in any of the various types of memory systems as exemplified above.

By way of example but not limitation, the controller 130 and the memory device 150 may be integrated into a single semiconductor device. The controller 130 and memory device 150 may be so integrated to form an SSD for improving operation speed. When the memory system 110 is used as an SSD, the operating speed of the host 102 connected to the memory system 110 can be improved more than that of the host 102 connected with a hard disk. In another embodiment, the controller 130 and the memory device 150 may be integrated into one semiconductor device to form a memory card, such as a PC card (PCMCIA), a compact flash card (CF), a smart media card (e.g., SM, SMC), a memory stick, a multimedia card (e.g., MMC, RS-MMC, MMCmicro), a secure digital (SD) card (e.g., SD, miniSD, microSD, SDHC), or a universal flash memory.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device and may retain data stored therein even while electrical power is not supplied. The memory device 150 may store data provided from the host 102 through a write operation, while providing data stored therein to the host 102 through a read operation. The memory device 150 may include a plurality of memory blocks 152, 154, 156, each of which may include a plurality of pages. Each of the plurality of pages may include a plurality of memory cells to which a plurality of word lines (WL) are electrically coupled. The memory device 150 also includes a plurality of memory dies, each of which includes a plurality of planes, each of which includes memory blocks, among the plurality of memory blocks 152, 154, 156. In addition, the memory device 150 may be a non-volatile memory device, for example a flash memory, wherein the flash memory may be a three-dimensional stack structure.

The controller 130 may control overall operations of the memory device 150, such as read, write, program, and erase operations. For example, the controller 130 may control the memory device 150 in response to a request from the host 102. The controller 130 may provide the data, read from the memory device 150, to the host 102. The controller 130 may store the data, provided by the host 102, into the memory device 150.

The controller 130 may include a host interface (I/F) 132, a processor 134, an error correction code (ECC) circuitry 138, a power management unit (PMU) 140, a memory interface (I/F) 142 and a memory 144, all operatively coupled via an internal bus.

The host interface 132 may process commands and data provided from the host 102, and may communicate with the host 102 through at least one of various interface protocols, such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE). In accordance with an embodiment, the host interface 132 is a component for exchanging data with the host 102, which may be implemented through firmware called a host interface layer (HIL).

The ECC circuitry 138 may correct error bits of the data to be processed in (e.g., outputted from) the memory device 150, which may include an ECC encoder and an ECC decoder. Here, the ECC encoder may perform error correction encoding of data to be programmed in the memory device 150 to generate encoded data into which a parity bit is added and store the encoded data in the memory device 150. The ECC decoder may detect and correct errors contained in a data read from the memory device 150 when the controller 130 reads the data stored in the memory device 150. In other words, after performing error correction decoding on the data read from the memory device 150, the ECC circuitry 138 may determine whether the error correction decoding has succeeded and output an instruction signal (e.g., a correction success signal or a correction fail signal). The ECC circuitry 138 may use the parity bit which is generated during the ECC encoding process, for correcting the error bit of the read data. When the number of error bits is greater than or equal to a threshold number of correctable error bits, the ECC circuitry 138 may not correct error bits but instead may output an error correction fail signal indicating failure in correcting the error bits.

The ECC circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM). The ECC circuitry 138 may include any and all circuits, modules, systems or devices for performing the error correction operation based on at least one of the above described codes.

The PMU 140 may manage electrical power provided in the controller 130. For example, the PMU 140 may detect the power-on and the power-off. In addition, the PMU 140 may include a power detector.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134 in a case when the memory device 150 is a flash memory and, in particular, when the memory device 150 is a NAND flash memory. The memory interface 142 may provide an interface for handling commands and data between the controller 130 and the memory device 150, for example, operations of NAND flash interface, in particular, operations between the controller 130 and the memory device 150. In accordance with an embodiment, the memory interface 142 may be implemented through firmware called a flash interface layer (FIL) as a component for exchanging data with the memory device 150.

The memory 144 may support operations performed by the memory system 110 and the controller 130. The memory 144 may store temporary or transactional data generated or delivered for operations in the memory system 110 and the controller 130. The controller 130 may control the memory device 150 in response to a request from the host 102. The controller 130 may deliver data read from the memory device 150 into the host 102. The controller 130 may store data entered through the host 102 within the memory device 150. The memory 144 may be used to store data required for the controller 130 and the memory device 150 to perform operations such as read operations or program/write operations.

The performance information OPINFO generated by the performance information generation block 1301 described above with reference to FIG. 1 may be temporarily stored in the memory 144 before being stored in the memory device 150 by the performance information analysis block 1302. In addition, the performance information analysis block 1302 described above with reference to FIG. 1 may temporarily store the accumulated pieces of performance information OPINFO<1:N>, which are read from the memory device 150, in the memory 144, and then analyze values of the pieces of performance information OPINFO<1:N>.

The memory 144 may be implemented with a volatile memory. The memory 144 may be implemented with a static random access memory (SRAM), a dynamic random access memory (DRAM) or both. Although FIG. 2 exemplifies the memory 144 disposed within the controller 130, the present invention is not limited to that arrangement. That is, the memory 144 may be within or external to the controller 130. For instance, the memory 144 may be embodied by an external volatile memory having a memory interface transferring data and/or signals between the memory 144 and the controller 130.

The memory 144 may store data for performing operations such as data writing and data reading requested by the host 102 and/or data transfer between the memory device 150 and the controller 130 for background operations such as garbage collection and wear levelling as described above. In accordance with an embodiment, for supporting operations in the memory system 110, the memory 144 may include a program memory, a data memory, a write buffer/cache, a read buffer/cache, a data buffer/cache and a map buffer/cache.

The processor 134 may be implemented with a microprocessor or a central processing unit (CPU). The memory system 110 may include one or more processors 134. The processor 134 may control the overall operations of the memory system 110. By way of example but not limitation, the processor 134 can control a program operation or a read operation of the memory device 150, in response to a write request or a read request entered from the host 102. In accordance with an embodiment, the processor 134 may use or execute firmware to control the overall operations of the memory system 110. Herein, the firmware may be a flash translation layer (FTL). The FTL may serve as an interface between the host 102 and the memory device 150. The host 102 may transmit requests for write and read operations to the memory device 150 through the FTL.

In some embodiments, the processor 134 and the memory interface unit 142 may be used to perform the operations of the performance information generation block 1301, the performance information analysis block 1302 and the internal operation performance block 1303 described above with reference to FIG. 1.

The FTL may manage operations of address mapping, garbage collection, wear-leveling and so forth. Particularly, the FTL may load, generate, update, or store map data. Therefore, the controller 130 may map a logical address, which is entered from the host 102, with a physical address of the memory device 150 through the map data. The memory device 150 may otherwise function as a general storage device to perform a read or write operation because of the address mapping operation. Also, through the address mapping operation based on the map data, when the controller 130 tries to update data stored in a particular page, the controller 130 may program the updated data on another empty page and may invalidate old data of the particular page (e.g., update a physical address, corresponding to a logical address of the updated data, from the particular page to the newly programed page) due to a characteristic of a flash memory device. Further, the controller 130 may store map data of the new data into the FTL.

For example, when performing an operation requested from the host 102 in the memory device 150, the controller 130 uses the processor 134. The processor 134 engaged with the memory device 150 may handle instructions or commands corresponding to an inputted command from the host 102. The controller 130 may perform a foreground operation as a command operation, corresponding to an command from the host 102, such as a program operation corresponding to a write command, a read operation corresponding to a read command, an erase/discard operation corresponding to an erase/discard command and a parameter set operation corresponding to a set parameter command or a set feature command with a set command.

For another example, the controller 130 may perform a background operation on the memory device 150 through the processor 134. By way of example but not limitation, the background operation for the memory device 150 includes copying data in a memory block, among the memory blocks 152, 154, 156, and storing such data in another memory block (e.g., a garbage collection (GC) operation). The background operation may include an operation to move data stored in at least one of the memory blocks 152, 154, 156 in the memory device 150, into at least another of the memory blocks 152, 154, 156 (e.g., a wear leveling (WL) operation). During a background operation, the controller 130 may use the processor 134 for storing the map data stored in the controller 130 to at least one of the memory blocks 152, 154, 156, e.g., a map flush operation. A bad block management operation of checking for bad blocks among the plurality of memory blocks 152, 154, 156 is another example of a background operation performed by the processor 134.

In the memory system 110, the controller 130 performs a plurality of command operations corresponding to a plurality of commands received from the host 102. For example, when performing a plurality of program operations corresponding to plural program commands, a plurality of read operations corresponding to plural read commands and a plurality of erase operations corresponding to plural erase commands sequentially, randomly or alternatively, the controller 130 may determine which channel(s) or way(s) for connecting the controller 130 to which memory die(s) in the memory 150 is/are proper or appropriate for performing each operation. The controller 130 may send or transmit data or instructions via the determined channel(s) or way(s) for performing each operation. The plurality of memory dies may transmit an operation result via the same channel(s) or way(s), respectively, after each operation is complete. Then, the controller 130 may transmit a response or an acknowledge signal to the host 102. In an embodiment, the controller 130 may check a status of each channel or each way. In response to a command received from the host 102, the controller 130 may select at least one channel or way based on the status of each channel or each way so that instructions and/or operation results with data may be delivered via selected channel(s) or way(s).

The controller 130 may check the states of a plurality of channels (or ways) coupled to a plurality of memory dies that are included in the memory device 150.

By way of example but not limitation, the controller 130 may recognize statuses regarding channels (or ways) associated with memory dies in the memory device 150. The controller 130 may determine each channel or each way as being in a busy state, a ready state, an active state, an idle state, a normal state, or an abnormal state. The controller's determination of which channel or way an instruction (and/or a data) is delivered through can be based on a physical block address, e.g., to which die(s) the instruction (and/or the data) is delivered. The controller 130 may refer to descriptors delivered from the memory device 150. The descriptors may include a block or page of parameters that describe informative items about the memory device 150, which is a data with a set format or structure. For instance, the descriptors may include device descriptors, configuration descriptors, unit descriptors, and the like. The controller 130 can refer to, or use, the descriptors to determine which channel(s) or way(s) an instruction or a data is exchanged.

A management unit (not shown) may be included in the processor 134. The management unit may perform bad block management of the memory device 150. The management unit may find bad memory blocks, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may seriously aggravate the utilization efficiency of the memory device 150 having a 3D stack structure and the reliability of the memory system 110. Thus, reliable bad block management may enhance or improve performance of the memory system 110.

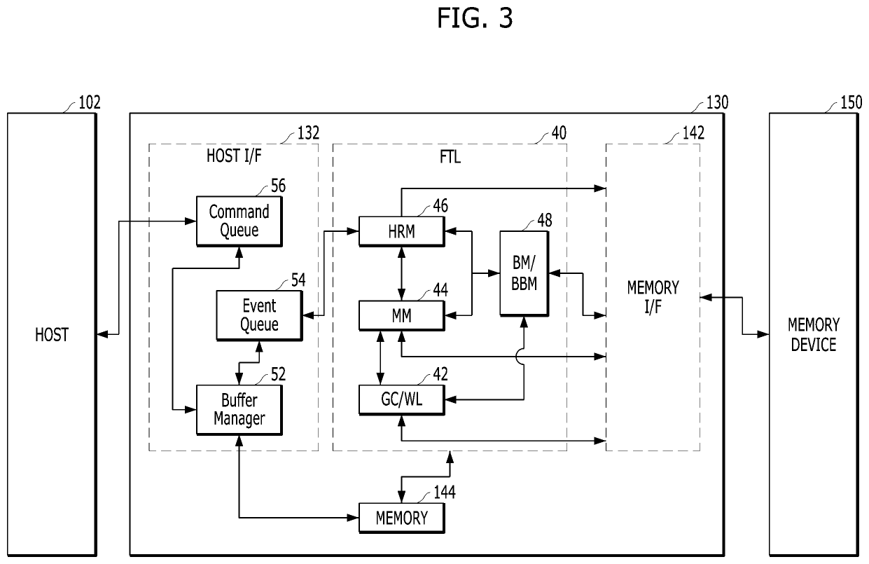

FIG. 3 is a block diagram illustrating a controller in a memory system in accordance with another embodiment of the present invention.

Referring to FIG. 3, the controller 130 cooperates with the host 102 and the memory device 150. The controller 130 may include a host interface (I/F) 132, a flash translation layer (FTL) circuitry 40, a memory interface (I/F) 142 and a memory 144.

Although not shown in FIG. 3, in accordance with an embodiment, the ECC circuitry 138 in FIG. 2 may be included in the flash translation layer (FTL) circuitry 40. In another embodiment, the ECC circuitry 138 may be implemented as a separate module, a circuit, or firmware, which is included in, or associated with, the controller 130.

In some embodiments, the flash translation layer (FTL) unit 40 and the memory interface unit 142 may serve as the performance information generation block 1301, the performance information analysis block 1302 and the internal operation performance block 1303 described above with reference to FIG. 1.

The host interface 132 is for handling commands and data from the host 102. By way of example but not limitation, the host interface 132 may include a command queue 56, a buffer manager 52 and an event queue 54. The command queue 56 may sequentially store commands and data from the host 102 and output the commands and data to the buffer manager 52 in a stored order. The buffer manager 52 may classify, manage or adjust the commands and the data, which are delivered from the command queue 56. The event queue 54 may sequentially transmit events for processing the commands and the data, from the buffer manager 52.

A plurality of commands or data of the same characteristic may be continuously received from the host 102, or commands and data of different characteristics may be transmitted to the memory system 110 after being mixed or jumbled. For example, a plurality of commands for reading data (i.e., read commands) may be delivered, or read commands and program/write commands may be alternately transmitted to the memory system 110. The host interface 132 may store commands and data, which are received from the host 102, to the command queue 56 sequentially. Thereafter, the host interface 132 may estimate or predict what type of internal operation the controller 130 will perform according to the characteristics of the command and data, which is received from the host 102. The host interface 132 may determine a processing order and a priority of commands and data, based at least on their characteristics.

According to characteristics of commands and data received from the host 102, the buffer manager 52 in the host interface 132 is configured to determine whether the buffer manager 52 should store commands and data in the memory 144, or whether the buffer manager 52 should deliver the commands and the data into the flash translation layer (FTL) circuitry 40. The event queue 54 receives events, entered from the buffer manager 52, which are to be internally executed and processed by the memory system 110 or the controller 130 in response to the commands and the data from the host 102, so as to deliver the events into the flash translation layer (FTL) circuitry 40 in the order received.

In accordance with an embodiment, the host interface 132 in FIG. 3 may perform the functions of the controller 130 in FIG. 2.

In accordance with an embodiment, the flash translation layer (FTL) circuitry 40 may include a state manager (GC/WL) 42, a map manager (MM) 44, a host request manager (HRM) 46, and a block manager (BM/BBM) 48. The host request manager 46 may manage the events entered from the event queue 54. The map manager 44 may handle or control a map data. The state manager 42 may perform garbage collection (GC) or wear leveling (WL). The block manager 48 may execute commands or instructions onto a block in the memory device 150.

By way of example but not limitation, the host request manager 46 may use the map manager 44 and the block manager 48 to handle or process requests according to the read and program commands, and events which are delivered from the host interface 132. The host request manager 46 may send an inquiry request to the map data manager 44, to determine a physical address corresponding to the logical address which is entered with the events. The host request manager 46 may send a read request with the physical address to the memory interface 142, to process the read request (handle the events). On the other hand, the host request manager 46 may send a program request (or write request) to the block manager 48, to program entered data to an empty page (i.e., a page having no data) in the memory device 150, and then, may transmit a map update request corresponding to the program request to the map manager 44, to update an item relevant to the programmed data in information of mapping the logical-physical addresses to each other.

Here, the block manager 48 may convert a program request delivered from the host request manager 46, the map data manager 44, and/or the state manager 42 into a flash program request used for the memory device 150, to manage flash blocks in the memory device 150. In order to maximize or enhance program or write performance of the memory system 110 (see FIG. 2), the block manager 48 may collect program requests and send flash program requests for multiple-plane and one-shot program operations to the memory interface 142. The block manager 48 may send several flash program requests to the memory interface 142 to enhance or maximize parallel processing of the multi-channel and multi-directional flash controller.

The block manager 48 may be configured to manage blocks in the memory device 150 according to the number of valid pages, select and erase blocks having no valid pages when a free block is needed, and select a block including the least number of valid pages when it is determined that garbage collection is necessary. The state manager 42 may perform garbage collection to move the valid data to an empty block and erase remaining data in the blocks from which the valid data was moved so that the block manager 48 may have enough free blocks (i.e., empty blocks with no data). If the block manager 48 provides information regarding a block to be erased to the state manager 42, the state manager 42 is able to check all flash pages of the block to be erased to determine whether each page is valid. For example, to determine validity of each page, the state manager 42 may identify a logical address stored in an out-of-band (00B) area of each page. To determine whether each page is valid, the state manager 42 may compare the physical address of the page with the physical address mapped to the logical address obtained from the request. The state manager 42 sends a program request to the block manager 48 for each valid page. A mapping table may be updated through the update of the map manager 44 when the program operation is complete.

The map manager 44 may manage a logical-physical mapping table. The map manager 44 may process requests such as queries and updates, which are generated by the host request manager 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request may be sent to the block manager 48 so that a clean cache block is made and the dirty map table may be stored in the memory device 150.

When garbage collection is performed, the state manager 42 copies valid page(s) into a free block, and the host request manager 46 may program the latest version of the data for the same logical address of the page and currently issue an update request. When the state manager 42 requests the map update in a state in which copying of valid page(s) has not been completed, the map manager 44 may not perform the mapping table update. This is because the map request is issued with old physical information if the state manger 42 requests a map update and a valid page copy is not completed until later. The map manager 44 may perform a map update operation to ensure accuracy only if the latest map table still points to the old physical address.

The memory device 150 may include a plurality of memory blocks. Each of the plurality of memory blocks may be a single level cell (SLC) memory block or a multi level cell (MLC) memory block, according to the number of bits that can be stored or represented in one memory cell of such block. Here, the SLC memory block includes a plurality of pages implemented by memory cells, each storing one bit of data. The SLC memory block can have high data I/O operation performance and high durability. The MLC memory block includes a plurality of pages implemented by memory cells, each storing multi-bit data (e.g., two bits or more). The MLC memory block can have a larger storage capacity for the same space compared to the SLC memory block. The MLC memory block can be highly integrated in terms of storage capacity. In an embodiment, the memory device 150 may be implemented with MLC memory blocks, such as a double level cell memory block, a triple level cell (TLC) memory block, a quadruple level cell (QLC) memory block and a combination thereof. The double level memory block may include a plurality of pages implemented by memory cells, each capable of storing 2-bit data. The triple level cell (TLC) memory block may include a plurality of pages implemented by memory cells, each capable of storing 3-bit data. The quadruple level cell (QLC) memory block may include a plurality of pages implemented by memory cells, each capable of storing 4-bit data. In another embodiment, the memory device 150 may be implemented with a block including a plurality of pages implemented by memory cells, each capable of storing 5-bit or more bit data.

In an embodiment of the disclosure, the memory device 150 is embodied as a nonvolatile memory such as a flash memory such as a NAND flash memory, a NOR flash memory and the like. In another embodiment, the memory device 150 may be implemented by at least one of a phase change random access memory (PCRAM), a ferroelectrics random access memory (FRAM) and a spin injection magnetic memory (e.g., a spin transfer torque magnetic random access memory (STT-M RAM)).

FIG. 4 is a table illustrating a first example of an operating method of the memory system 110 according to an embodiment of the present invention.

Referring to FIG. 4, when a plurality of pieces of performance information OPINFO<1:N> are accumulated during a predetermined time duration of a plurality of periods, various cases CASE<1:5> for analyzing the value pattern thereof will be described. At this time, according to each of the cases CASE<1:5>, values of performance information OPINFO<N+1>, which are to be accumulated at the subsequent period, may be determined differently.

In FIG. 4, a total of 11 pieces of performance information OPINFO<1:11> are accumulated during a predetermined time duration of 11 periods. In addition, the performance information analysis block 1302 analyzes ten pieces of performance information OPINFO<2:11> among the 11 pieces of performance information OPINFO<1:11>, and then predicts a value of a 12^{th} performance information OPINFO<12>, which is to be accumulated for the 12^{th} period.

In the first case CASE<1>, as a result of analyzing the value pattern of the ten pieces of performance information OPINFO<2:11>, which are the analysis targets of the performance information analysis block 1302, it may be seen that the ten pieces of performance information OPINFO<2:11> have a value pattern indicating that the internal operation is performable for two periods and then the internal operation is unperformable for two periods. In other words, since the second performance information OPINFO<2> has a value indicating that the internal operation is unperformable but the third performance information OPINFO<3> and the fourth performance information OPINFO<4> have values indicating that the internal operation is performable, the fifth performance information OPINFO<5> and the sixth performance information OPINFO<6> have values indicating that the internal operation is unperformable, and the seventh performance information OPINFO<7> and the eighth performance information OPINFO<8> have values indicating that the internal operation is performable, and the ninth performance information OPINFO<9> and the tenth performance information OPINFO<10> have values indicating that the internal operation is unperformable, it may be seen that the pieces of performance information OPINFO<3:10> have a value pattern indicating that the internal operation is performable for two periods and then the internal operation is unperformable for two periods. At this time, since the 11^{th} performance information OPINFO<11> has a value indicating that the internal operation is performable, the 12^{th} performance information OPINFO<12> may be predicted to have a value indicating that the internal operation is performable.

In the second case CASE<2>, as a result of analyzing the value pattern of the ten pieces of performance information OPINFO<2:11>, which are the analysis targets of the performance information analysis block 1302, it may be seen that the ten pieces of performance information OPINFO<2:11> have a value pattern indicating that the internal operation is performable for three periods and then the internal operation is unperformable for three periods. In other words, since the second performance information OPINFO<2>, the third performance information OPINFO<3> and the fourth performance information OPINFO<4> have values indicating that the internal operation is performable, the fifth performance information OPINFO<5>, the sixth performance information OPINFO<6> and the seventh performance information OPINFO<7> have values indicating that the internal operation is unperformable, and the eighth performance information OPINFO<8>, the ninth performance information OPINFO<9> and the tenth performance information OPINFO<10> have values indicating that the internal operation is performable, it may be seen that the pieces of performance information OPINFO<2:10> have a value pattern indicating that the internal operation is performable for three periods and then the value indicating that the internal operation is unperformable for three periods. At this time, since the 11^{th} performance information OPINFO<11> has a value indicating that the internal operation is unperformable, the 12^{th} performance information OPINFO<12> may be predicted to have a value indicating that the internal operation is unperformable.

In the third case CASE<3>, as a result of analyzing the value pattern of the ten pieces of performance information OPINFO<2:11>, which are the analysis targets of the performance information analysis block 1302, it may be seen that the ten pieces of performance information OPINFO<2:11> have a value pattern indicating that the internal operation is performable for several periods, and then the internal operation is unperformable for remaining periods. In other words, since the second performance information OPINFO<2>, the third performance information OPINFO<3>, the fourth performance information OPINFO<4>, the fifth performance information OPINFO<5>, the sixth performance information OPINFO<6>, the seventh performance information OPINFO<7> and the eighth performance information OPINFO<8> have values indicating that the internal operation is performable but the ninth performance information OPINFO<9>, the tenth performance information OPINFO<10> and the 11^{th} performance information OPINFO<11> have values indicating that the internal operation is unperformable, it may be seen that the ten pieces of performance information OPINFO<2:11> have values indicating that the internal operation is performable for several previous periods and then the values indicating that the internal operation is unperformable for remaining periods. At this time, since the ninth performance information OPINFO<9>, the tenth performance information OPINFO<10> and the 11^{th} performance information OPINFO<11> have the values indicating that the internal operation is unperformable, the 12^{th} performance information OPINFO<12> may be predicted to have a value indicating that the internal operation is unperformable.

In the fourth case CASE<4>, as a result of analyzing the value pattern of the ten pieces of performance information OPINFO<2:11>, which are the analysis targets of the performance information analysis block 1302, it may be seen that the ten pieces of performance information OPINFO<2:11> have a value pattern indicating that the internal operation is unperformable for several periods, and then the internal operation is performable for remaining periods. In other words, since the second performance information OPINFO<2>, the third performance information OPINFO<3>, the fourth performance information OPINFO<4> and the fifth performance information OPINFO<5> have values indicating that the internal operation is unperformable but the sixth performance information OPINFO<6>, the seventh performance information OPINFO<7>, the eighth performance information OPINFO<8>, the ninth performance information OPINFO<9>, the tenth performance information OPINFO<10> and the 11^{th} performance information OPINFO<11> have values indicating that the internal operation is performable, it may be seen that the ten pieces of performance information OPINFO<2:11> have values indicating that the internal operation is unperformable for several previous periods and then the internal operation is performable for remaining periods. At this time, since the sixth performance information OPINFO<6>, the seventh performance information OPINFO<7>, the eighth performance information OPINFO<8>, the ninth performance information OPINFO<9>, the tenth performance information OPINFO<10> and the 11^{th} performance information OPINFO<11> have the values indicating that the internal operation is performable, the 12^{th} performance information OPINFO<12> may be predicted to have a value indicating that the internal operation is performable.

In the fifth case CASE<5>, as a result of analyzing the value pattern of the ten pieces of performance information OPINFO<2:11>, which are the analysis targets of the performance information analysis block 1302, it may be seen that the value pattern of the ten pieces of performance information OPINFO<2:11> does not have a particular tendency. In other words, since the second performance information OPINFO<2> has a value indicating that the internal operation is unperformable, the third performance information OPINFO<3> has a value indicating that the internal operation is performable, the fourth performance information OPINFO<4> has a value indicating that the internal operation is unperformable, the fifth performance information OPINFO<5> has a value indicating that the internal operation is performable, the sixth performance information OPINFO<6> and the seventh performance information OPINFO<7> have values indicating that the internal operation is unperformable, the eighth performance information OPINFO<8>, the ninth performance information OPINFO<9> and the tenth performance information OPINFO<10> have values indicating that the internal operation is performable, and the 11^{th} performance information OPINFO<11> has a value indicating that the internal operation is unperformable, it may be seen that the value pattern of the ten pieces of performance information OPINFO<2:11> does not have a particular tendency. In this case, the 12^{th} performance information OPINFO<12> may be estimated to have a value indicating that the internal operation is unperformable so that the internal operation cannot be performed at each period.

For reference, unlike the above embodiment illustrated in FIG. 4, the performance information analysis block 1302 may analyze all of the 11 pieces of performance information OPINFO<1:11> accumulated during the predetermined time duration of 11 periods, and predict the value of the 12^{th} performance information OPINFO<12>, which is to be accumulated at the 12^{th} period.

The effects on the device according to the present disclosure are described as follows.

The memory system and the data processing system according to the embodiments of the present disclosure may predict whether an internal operation of the memory system is performable without a command from the host for a predetermined time after a set time point, based on system information inputted from the host at each period that is repeated for each predetermined time, and then may perform the internal operation for the predetermined time from the set time point according to a result of the prediction. Accordingly, it is possible to stably perform the internal operation of the memory system by predicting that the time point that does not affect input/output performance between the host and the memory system.

While the present disclosure has been described with respect to specific embodiments, it will be apparent to those skilled in the art that various changes and modifications may be made without departing from the spirit and scope of the disclosure as defined in the following claims.

What is claimed is:

1. A memory system comprising:
a memory device including a plurality of memory blocks; and
a controller suitable for:
periodically generating, based on system information periodically inputted from a host, performance information indicating whether an internal operation to be performed on the plurality of memory blocks without a command inputted from the host is performable;
accumulatively storing the generated performance information;
determining whether the internal operation is performable within a period subsequent to a current period based on the accumulated performance information; and
performing the internal operation on the memory blocks during the subsequent period according to a result of the determination.

2. The memory system of claim 1, wherein the system information includes:
power supply information indicating stability and sustainability of power supply within each period;
reservation operation information indicating whether a command to be transmitted from the host is present within each period; and
operation environment information on an operation environment of the host within each period.

3. The memory system of claim 2, wherein the controller generates the performance information indicating the internal operation is performable at each period when the controller determines the power supply is stable and sustainable within the period, the command to be transmitted from the host within the period is not present and the operation environment is an environment in which the internal operation is performable within the period.

4. The memory system of claim 3, wherein the controller determines whether the internal operation is performable within the subsequent period based on one or more most recent pieces within the accumulated performance information.

5. The memory system of claim 4, wherein the controller determines whether the internal operation is performable within the subsequent period based on a pattern of the most recent pieces.

6. The memory system of claim 4,
wherein the controller determines the internal operation is unperformable within the subsequent period when the controller does not detect the pattern as having any tendency or detects the pattern as indicating that the internal operation is unperformable within the subsequent period, and
wherein the controller skips the internal operation within the subsequent period when the controller determines the internal operation is unperformable within the subsequent period.

7. The memory system of claim 3, wherein the operation environment information includes at least one of pieces of information on a temperature and information on mobility of the memory system.

8. The memory system of claim 1, wherein the controller is further suitable for interrupting the internal operation and performing an operation in response to a command, which is inputted from the host while the internal operation is being performed.

9. The memory system of claim 1,
wherein, when the internal operation is an erase operation, the controller is further suitable for managing an erase block list for a block required to be erased among the plurality of memory blocks,
wherein, when the internal operation is a background operation, the controller is further suitable for managing a source block list for a block satisfying a reference condition of the background operation among the plurality of memory blocks,
wherein the controller performs the erase operation with reference to the erase block list, and
wherein the controller performs the background operation with reference to the source block list.

10. A data processing system comprising:
a host suitable for periodically generating and outputting system information; and
a memory system including a memory device that includes a plurality of memory blocks, and suitable for:
periodically generating, based on the system information, performance information indicating whether an internal operation to be performed on the plurality of memory blocks without a command inputted from the host is performable;
accumulatively storing the generated performance information;
determining whether the internal operation is performable within a period subsequent to a current period based on the accumulated performance information; and
performing the internal operation on the memory blocks during the subsequent period according to a result of the determination.

11. The data processing system of claim 10, wherein the system information includes:
power supply information indicating stability and sustainability of a power supply within each period;
reservation operation information indicating whether a command to be transmitted from the host is present within each period; and
operation environment information on an operation environment of the host within each period.

12. The data processing system of claim 11, wherein the memory system generates the performance information indicating the internal operation is performable at each period when the memory system determines the power supply is stable and sustainable within the period, the command to be transmitted from the host within the period is not present and the operation environment is an environment in which the internal operation is performable within the period.

13. The data processing system of claim 12, wherein the memory system determines whether the internal operation is performable within the subsequent period on a basis of one or more most recent pieces within the accumulated performance information.

14. The data processing system of claim 13, wherein the memory system determines whether the internal operation is performable within the subsequent period on a basis of a pattern of the most recent pieces.

15. The data processing system of claim 13,
wherein the memory system determines the internal operation is unperformable within the subsequent period when the memory system does not detect the pattern or detects the pattern as indicating that the internal operation is unperformable within the subsequent period, and
wherein the memory system skips the internal operation within the subsequent period when the memory system determines the internal operation is unperformable within the subsequent period.

16. The data processing system of claim 12, wherein the operation environment information includes at least one of pieces of information on a temperature and information on mobility of the memory system.

17. The data processing system of claim 10, wherein the memory system is further suitable for interrupting the internal operation and performing an operation in response to a command, which is inputted from the host while the internal operation is being performed.

18. The data processing system of claim 10,
wherein, when the internal operation is an erase operation, the memory system is further suitable for managing an erase block list for a block required to be erased among the plurality of memory blocks,
wherein, when the internal operation is a background operation, the memory system is further suitable for managing a source block list for a block satisfying a reference condition of the background operation among the plurality of memory blocks,
wherein the memory system performs the erase operation with reference to the erase block list, and
wherein the memory system performs the background operation with reference to the source block list.

19. The data processing system of claim 11, wherein the host is further suitable for, when the memory system is in a sleep mode, changing the sleep mode to a wake mode then outputting the system information to the memory system.

20. An operating method of a controller for controlling a memory device, the operating method comprising:
gathering, periodically and for a predetermined time duration, first information on performability of an internal operation of the memory device during each period; and
controlling the memory device to perform the internal operation based on a value pattern of the gathered first information,
wherein the first information is gathered at each period based on second information indicating one or more among:
stability and sustainability of a power supply within the period;
a command to be provided within the period, the command requesting a dependent operation of the memory device; and
an operation environment of the memory device within the period.
